(19) United States
(12) Patent Application Publication
(10) Pub. No.: US 2015/0125718 A1
(43) Pub. Date: May 7, 2015

(54) FIELD ACTIVATION FUEL CELL

(71) Applicant: Mark Minto, Mariposa, CA (US)

(72) Inventor: Mark Minto, Mariposa, CA (US)

(21) Appl. No.: 14/073,305

(22) Filed: Nov. 6, 2013

(51) Int. Cl. H01M 8/06; H01M 8/10

(52) U.S. Cl. CPC H01M 8/0656; H01M 8/1002
USPC 429/7; 429/422; 429/479

(57) ABSTRACT

An electric field activated fuel cell. Electrodes have sharp tips and are subjected to electric fields to generate ions. Ion conductive media may include polar solvents, liquid electrolytes, solid electrolytes and nonpolar solvent with phase transfer catalysts. Charge leaks preferentially from sharp electrode surface tips. Ionized fluid atoms and molecules migrate across the ion conductive media, leading to reaction completion and newly formed products.

### CROSS-REFERENCE TO RELATED APPLICATIONS

This application claims the benefit of U.S. provisional patent application Ser. No. 61/652,858, filed May 30, 2012 and Ser. No. 61/724,880, filed Nov. 11, 2012.

### BACKGROUND

### Prior Art

The following is a tabulation of some prior art that presently appears relevant:

| | | US Patents Issue | |
|---|---|---|---|
| Patent Number | Kind Code | Date/Pub date | Patentee |
| 2,004,352 | | 1935 Jun. 11 | Simon |
| 3,612,923 | A | 1971 Oct. 12 | Collier Edward L |
| 3,755,704 | | 1973 Aug. 28 | Spindt et al. |
| 5,213,911 | A | 1993 May 25 | Bloom et al. |
| 6,468,684 | B1 | 2002 Oct. 22 | Chisholm et al. |
| 6,713,206 | B2 | 2004 Mar. 30 | Markoski et al. |
| 7,588,694 | B1 | 2009 Sep. 15 | Robert W Bradshaw |
| | | | Douglas A. |
| | | | Brosseau |
| GB667298 | | 1950 Sep. 05 | Bacon, F. T. |
| 2010/0227120 | A1 | 2010 Sep. 09 | Haile et al. |
| EP20000102641 | B1 | 2000 Feb. 8 | Hiroki Fujita |

Fuel cells offer hope in a world of diminishing hydrocarbon resources. Many fuel cells operate at efficiencies as high as 60%. This contrasts with the internal combustion engine in an automobile, which typically operates at 20-25% efficiency. In comparison with piston engines, fuel cells also have lower emissions, and longer periods of steady operation with fewer maintenance requirements. Unfortunately, all fuel cells suffer from problems that have prevented wider adoption of the technology. These problems are related to the material requirements of the design. Most fuel cells need specific material components to operate. This is especially true of the parts of the fuel cell where chemical reactions are taking place and where ions flow. These names for these parts of the fuel cell are the anode, cathode and electrolyte.

In the anode, electrons are separated from the fuel. The fuel acquires a positive charge. These electrons travel through a wire to the load, where they perform work. After the load the electrons travel to the cathode. In the cathode, the electrons ionize oxygen. Oxygen acquires a negative charge. The ions are allowed to cross an electrolyte, in order to react. At the end of the reaction, the fluid fuel and oxygen have been converted to exhaust. These exhaust fluids are usually water and/or carbon dioxide.

Anode, cathode and electrolyte are general terms that are used for a variety of applications. Often, the anode and cathode are ordinary metal conductors, and operate quite simply as a source and sink of electrical current. However in a fuel cell, the anode and cathode may have additional responsibilities. In addition to current conduction, the anode and cathode are responsible for activating the fuel and oxygen. This activation includes ionization of the fuel and oxygen. The electrolyte then conducts these ions to meet and react. The anode, cathode and electrolyte need to activate the chemical species, catalyze a phase transition and complete a joined chemical reaction. Also, exhaust is vented. Hence, the functions of the anode, cathode and electrolyte include: chemical activation, ionization, conduction of ions, reaction completion, and ultimately exhaust.

In most fuel cell designs, the anode, cathode and electrolyte perform these functions over a short distance. Thickness leads to resistance losses, so fuel cell designers generally keep the components thin to reduce these losses. Yet, even though the layers may be very thin, they usually are of complex composition. For example, the location where oxygen is reduced in the cathode is called the triple phase boundary. This is the location where the electrolyte, gas, and electrically connected catalyst particles all meet. This mixture of materials is a solid, but the anode and cathode also need to be highly porous. While permitting reactant fluids to enter, they also need to allow exhaust gases to exit. To achieve the triple phase boundary, many fuels cell employ a dispersion of metal catalyst in the porous structures. Others use selected concentrations of metal oxides and/or a specific, stabilized, chemical phase of a solid in order to function correctly. Support materials are included as scaffolding or simply to hold the parts together. The three components, anode, electrolyte, and cathode, need to match. They should work together at the same temperature, and catalyze the same joined chemical reactions. Hence, the selection of materials for the anode, electrolyte and cathode is difficult, and the fabrication of these components is complicated.

Fuel cells differ according to the type of electrolyte. The simplest type of electrolyte is a polar solvent with dissolved salts. In battery and fuel cell applications, the function of an electrolyte is to conduct ions. In addition to liquid electrolytes, a wide group of materials are now known to conduct ions. These include, solid electrolytes, ion conductive membranes, ionic liquids, and even nonpolar solvents infused with phase transfer catalysts. Despite this wealth of types and phases of ion conductive media, only a few select electrolytes are used in fuel cell applications.

The Bacon cell is the name for the alkaline hydrogen cell. The electrolyte of the Bacon cell is usually aqueous potassium hydroxide. At the boundary between cathode and electrolyte, oxygen reacts with water to form hydroxide ions. These hydroxide ions migrate through the electrolyte to the anode. At the boundary between the anode and the electrolyte, hydrogen ions react with the hydroxide to form water. In the Bacon cell, hydroxide is the ion carried by the electrolyte.

Unfortunately, the Bacon cell needs pure oxygen to operate for long periods of time. Otherwise, if exposed to air, the electrolyte reacts with carbon dioxide to form insoluble potassium carbonate. The potassium carbonate plugs the electrolyte and eventually stops the operation of the fuel cell. Pure oxygen is expensive to produce. The Bacon cell also uses hydrogen fuel. Hydrogen fuel is more expensive to produce than gasoline, diesel and oil. Thus the Bacon cell suffers from expensive oxygen, hydrogen, and a difficult electrolyte that is easily clogged. These problems have prevented the Bacon cell from being widely adopted.

Proton exchange membrane (PEM) fuel cells are similar to the Bacon cell in that they consume oxygen and hydrogen. Although they may use an air cathode as a source of oxygen without clogging, the PEM fuel cells still have many problems. The electrolyte in the PEM fuel cell is Nafion. Nafion is an electrolyte that conducts hydrogen ions well, when properly moistened. Maintaining the correct moisture level in the Nafion becomes difficult as the fuel cell heats up. Nafion is also expensive. The PEM fuel cell uses platinum metal in the anode and cathode. Platinum is a scarce metal and is very expensive. No substitute for platinum has been found. Thus the PEM fuel cell has three expensive components: Nafion, hydrogen, and platinum. The expensive material costs and high fuel costs have prevented the PEM fuel cell from being widely adopted.

New materials have been developed for the hydrogen fuel cell. Chisholm (U.S. Pat. No. 6,468,684) introduced a family of electrolytes called solid acids. A candidate material, cesium dihydrogen phosphate (CsH₂PO₄) electrolyte, conducts hydrogen ions. CsH₂PO₄ is a solid above 100 degrees Celsius, and conducts hydrogen at moderate temperatures. In contrast to the PEM fuel cell, the CsH₂PO₄ fuel cell has a cheaper electrolyte, and reduced water management problems. Haile et al (US Pub #:2010/0227120) have even lowered electrode resistance losses. However, the solid acid fuel cell is still dependent on platinum catalyst, and expensive hydrogen fuel. These problems have prevented the solid acid fuel cell from being widely adopted.

The solid oxide fuel cell uses a different electrolyte. The most common electrolyte is a ceramic material, yttria stabilized zirconia. Yttria stabilized zirconia conducts oxygen ions. Conductivity is low, until high temperatures are reached. The operating temperature is often greater than 800 degrees Celsius. Lengthy startup periods are needed to reach these high temperatures. The high temperatures also increase the use of expensive, thermally resistant materials to insulate and support the fuel cell. The anode, cathode and interconnect material need to thermally expand at a similar rate as the electrolyte, or they will fracture and separate with thermal cycling. Hence the materials used for the cathode and anode are restricted, because these materials need similar thermal expansion characteristics. The anode is commonly made of nickel with yttria stabilized zirconia—a cermet. The cathode is usually made of lanthanum strontium manganite. Cermet and ceramics often require a difficult sintering process during manufacture. In addition to these problems, solid oxide fuel cells suffer from sulfur poisoning and coking in the anode. The fuel may need processing prior to entering the fuel cell. All of these problems have limited solid oxide fuel cells to stationary applications.

Newer materials have been researched in an attempt to lower operating temperatures. Bloom et al. (U.S. Pat. No. 5,213,911) introduced a Bismuth Aluminum oxide electrolyte (Bi₂Al₄O₉) which conducts oxygen at a lower temperature (600° C. to 800° C.). A variety of electrolyte materials are being considered. Examples include: LaGaO₃, copper-doped bismuth vanadium oxide (BICUVOX), Ba₂In₂O₅, calcia doped lanthanum germanium oxides, rare earth doped ceria, etc. Bismuth-containing electrolytes provide the lowest operating temperatures, however tests have shown them to be unstable. High temperatures are still required for all the electrolytes. None of these electrolytes have made significant headway in replacing yttria-stabilized zirconia.

Molten carbonate fuel cells use a molten carbonate salt electrolyte. Just as with the solid oxide fuel cell, the molten carbonate fuel cell operates at high temperatures. These high temperatures necessitate the use of expensive, thermally resistant materials to insulate and support the fuel cell. The high temperatures also cause lengthy startup times. However, the molten carbonate fuel cell has an additional problem. The high temperatures coupled with a corrosive electrolyte accelerate corrosion of the components. Corrosion issues, long startup times, and expensive, temperature resistant materials have restricted the molten carbonate fuel cell to stationary applications.

This review of fuel cell types have revealed many problems in the prior art. All of these fuel cells suffer from one or more of the following problems.

(a) The electrolyte becomes clogged with alkali carbonates.
(b) The electrolyte is expensive and suffers from the need of careful moisture maintenance.
(c) The anode and cathode require scarce and expensive catalyst metals.
(d) The fuel cell uses expensive hydrogen to operate.
(e) The fuel cell has lengthy startup times.
(f) High temperatures are required for chemical activation, and the fuel cell design uses expensive, temperature resistant materials (refractory ceramic, cermets, and metals)
(g) The anode is poisoned by sulfur in the fuel and suffers flow restrictions due to coking.
(h) Fuel treatment is necessary, prior to fuel entering cell.
(i) The choice of anode, cathode, electrolyte, and interconnect materials are restricted, in that they need to be carefully matched. They need to have nearly identical thermal expansion rates, and they need to catalyze a joined chemical reaction.
(j) High temperatures and a corrosive electrolyte cause accelerated corrosion of the fuel cell components.

### SUMMARY

The cathode, anode, and electrolyte, perform many functions. These include chemical activation, ionization, conduction of ions, and completion of the reaction. One or more aspects introduce processes of activation and ionization and conduction. These processes are new to fuel cell applications. These processes augment or serve as an alternative to prior art methods.

### Advantages

Accordingly, one advantage of one or more aspects includes a new method and structures for ion generation and chemical activation. High temperatures are not required. In addition, the anode and cathode achieve ionization without the use of expensive electrocatalytic metals. Additional advantages of one or more aspects include methods of chemical activation that are not limited to hydrogen fuel, and may be applied to other fuel sources such as ammonia, and hydrocarbon fuels. Additional aspects of one or more aspects include a much wider choice of materials for anode, cathode and electrolyte. The anode cathode and polar solvent/electrolyte materials may be chosen independently of one another and they do not need to have similar rates of thermal expansion. Other advantages will be apparent from a consideration of the drawings and ensuing description.

### DRAWINGS

### Figures

In the drawings, related figures have the same number but different alphabetic suffixes.

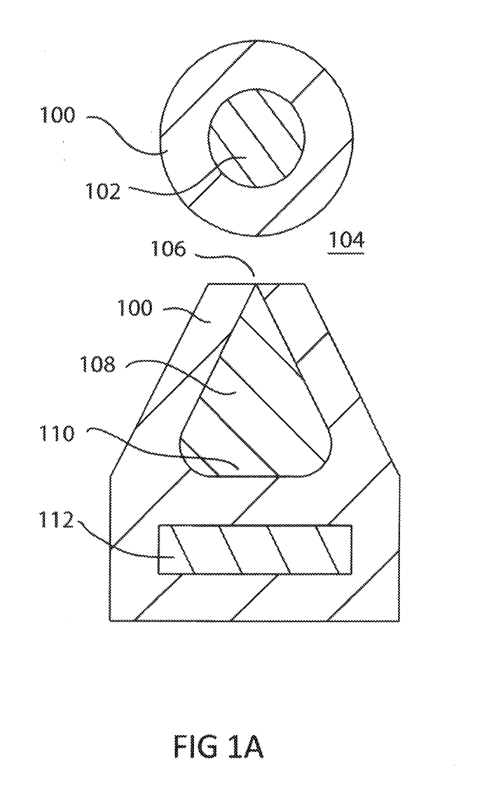

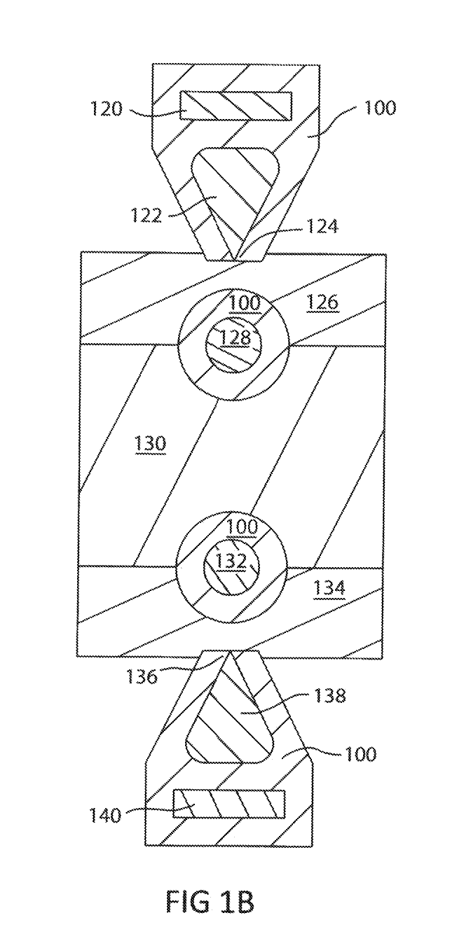

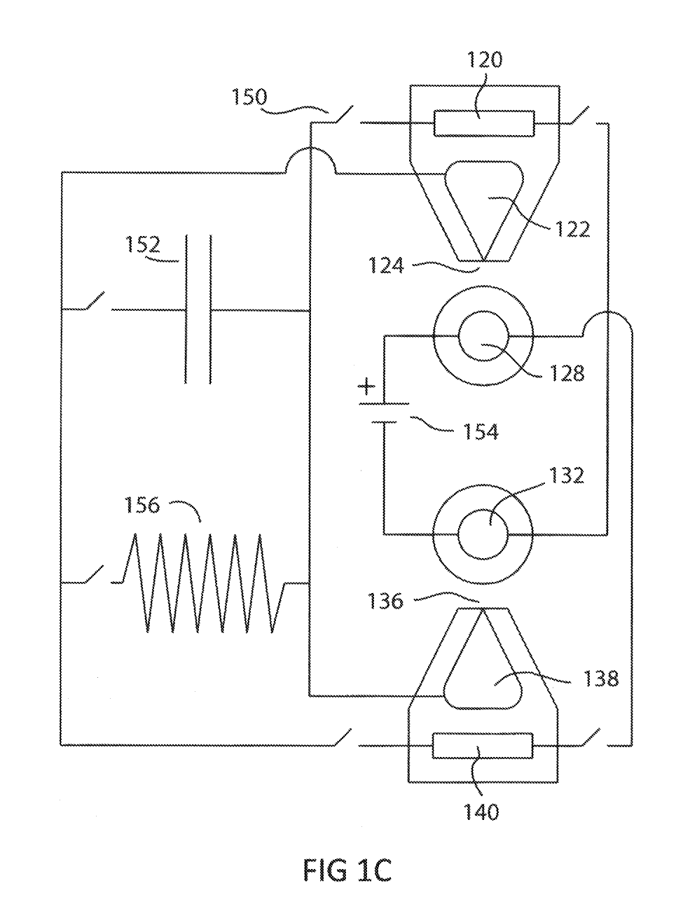

FIG. 1A shows a single sharp-tipped electrode immersed in an electric field provided by insulated capacitor plates above and below.

FIG. 1B shows an assembly of two electrodes as illustrated in FIG. 1A, with adjoining layers of polar solvent/electrolyte.

FIG. 1C shows a schematic electrical circuit connection to the electrically conductive components shown in FIG. 1B.

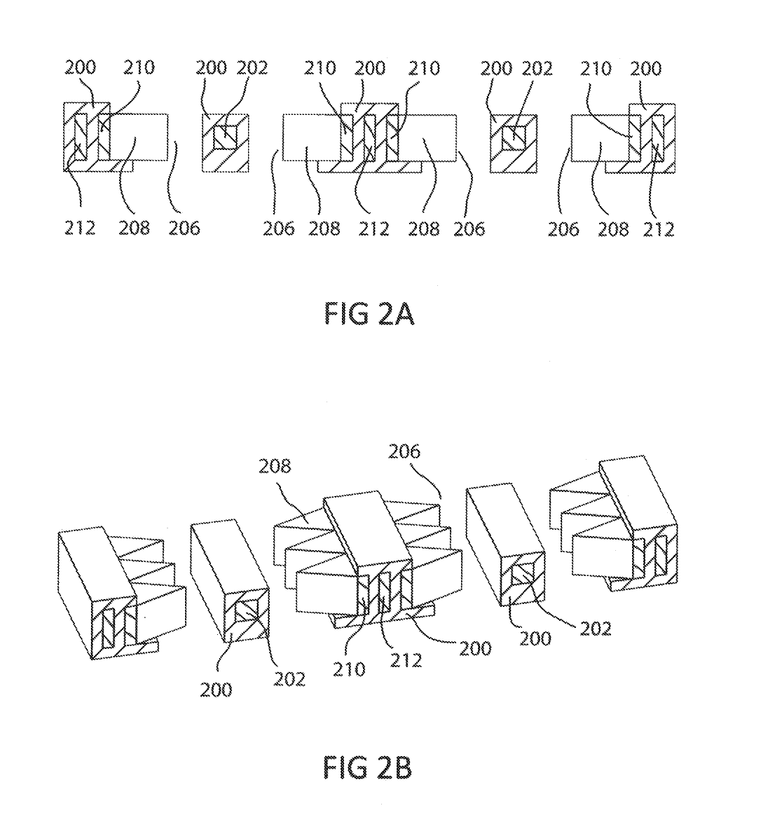

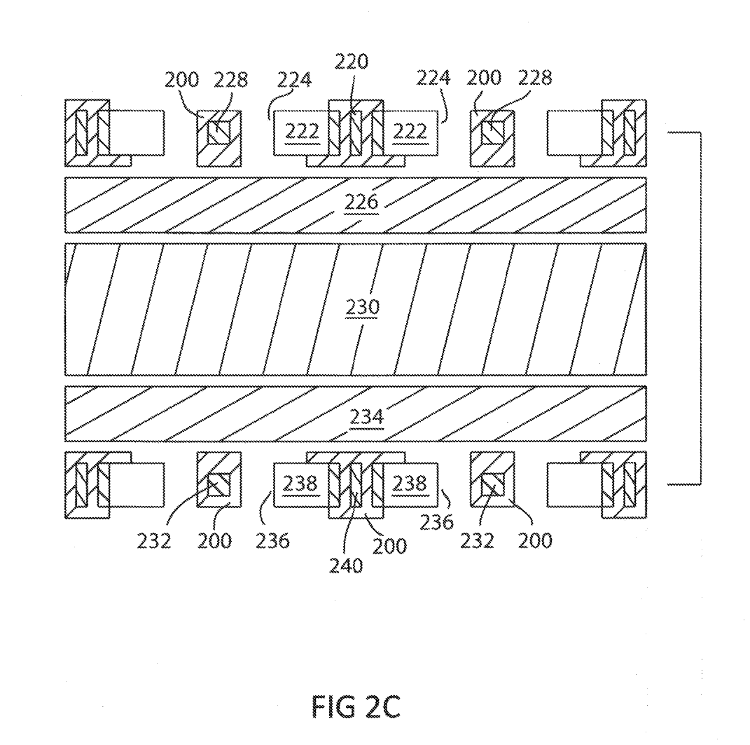

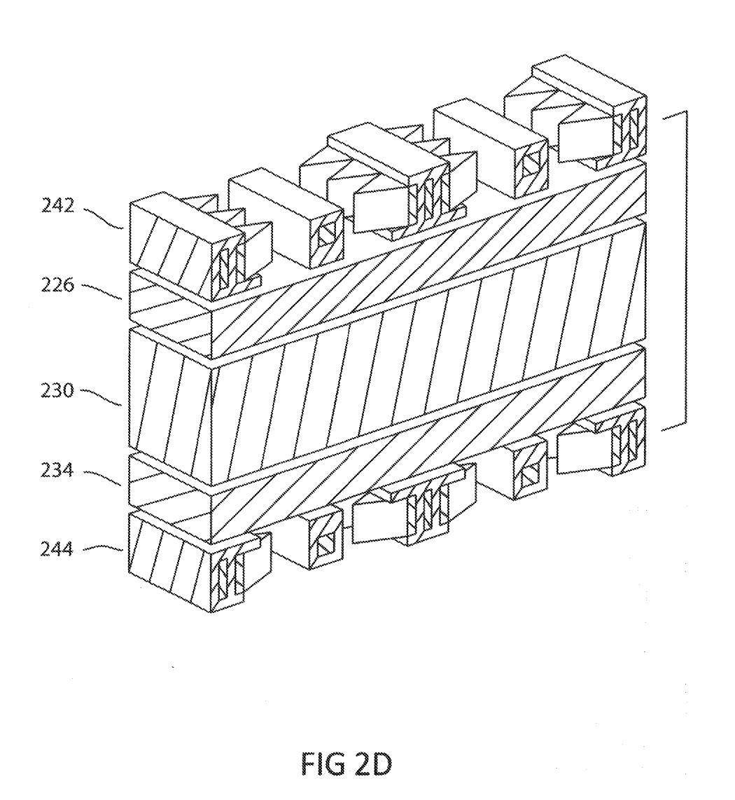

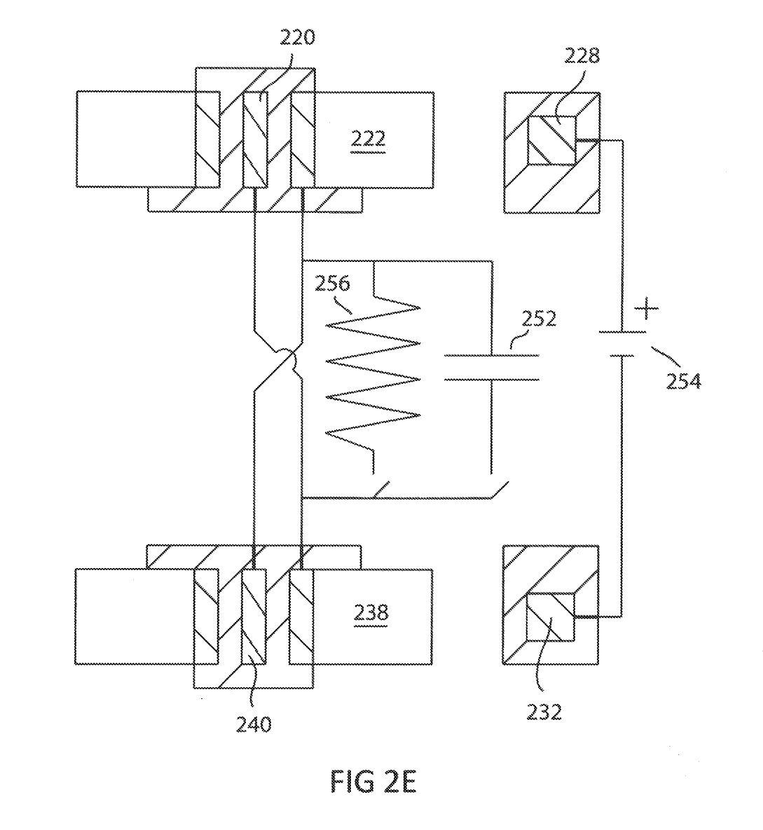

FIG. 2A shows an orthogonal view of an electrode array

FIG. 2B shows a perspective view of the array shown in FIG. 2A.

FIG. 2C shows an exploded orthogonal view of cathode array, anode array, and intermediate ion conductive layers.

FIG. 2D shows an exploded perspective view of FIG. 2C.

FIG. 2E shows a schematic electrical circuit connection to the electrically conductive components of FIGS. 2A-2D

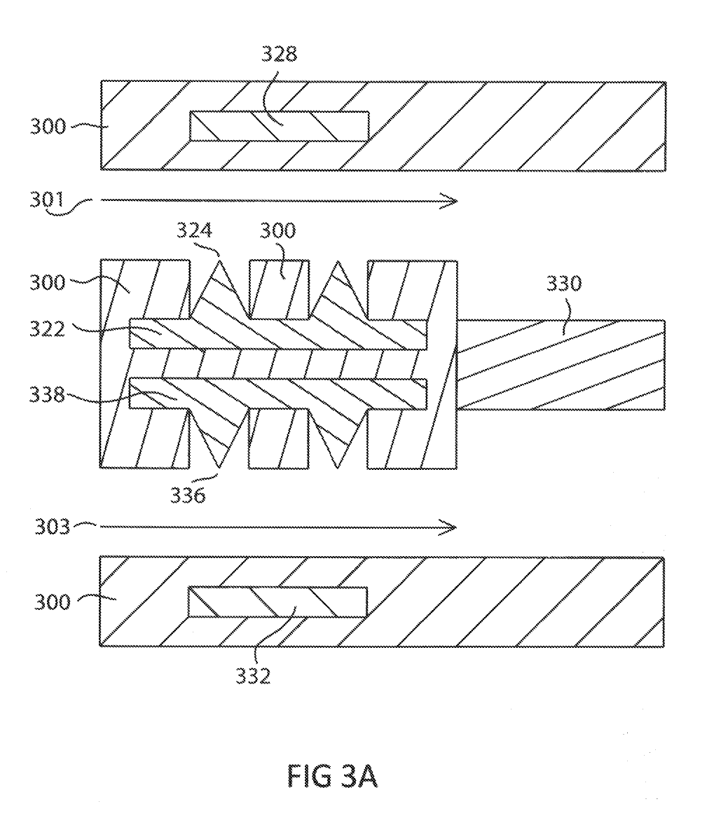

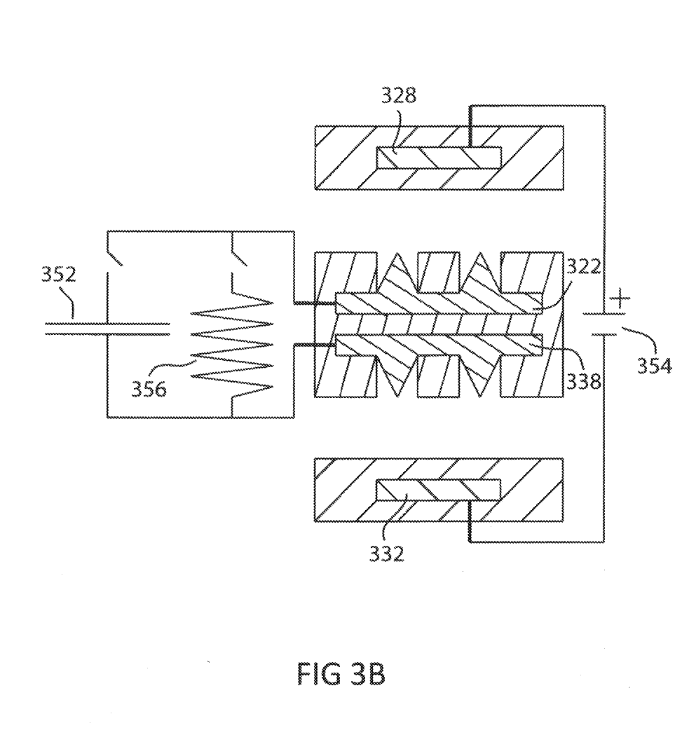

FIG. 3A shows two electrode arrays bracketed by fluid flow and tip plates

FIG. 3B shows a schematic electrical connection to the electrically conductive components of FIG. 3A

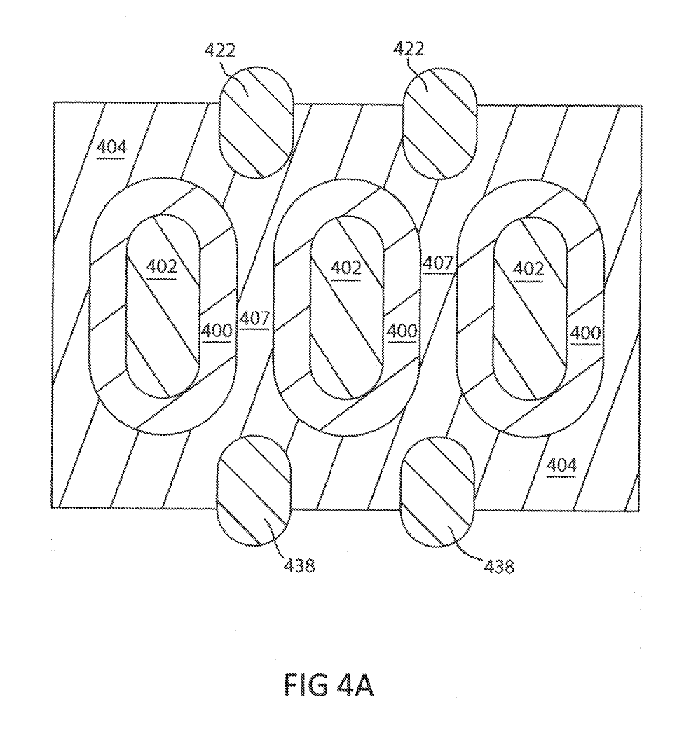

FIG. 4A shows an assembly of conductive plates, dielectric, and fluid, functioning as an ion conductive media.

### REFERENCE NUMERALS

100 electrically insulting dielectric
102 tip plate
104 fluid media
106 electrode tip
108 electrode
110 electrode base
112 base plate
120 cathode base plate
122 cathode
124 cathode tip
126 ion conductive media diffused with oxidant.
128 cathode tip plate
130 ion conductive media
132 anode tip plate
134 ion conductive media diffused with fuel
136 anode tip
138 anode
140 anode base plate
150 switch
152 capacitor
154 voltage/power supply
156 load
200 electrically insulting dielectric
202 tip plate
206 wedge electrode tip
208 electrode
210 wedge electrode base
212 base plate
220 cathode base plate
222 cathode
224 cathode tip
226 ion conductive media diffused with oxidant.
228 cathode tip plate
230 ion conductive media
232 anode tip plate
234 ion conductive media diffused with fuel
236 anode tip
238 anode
240 anode base plate
242 cathode array
244 anode array
300 electrically insulating dielectric
301 cathode fluid flow
303 anode fluid flow
322 cathode
324 cathode tip
328 cathode tip plate
330 ion conductive media/electrolyte
332 anode tip plate
336 anode tip
338 anode
332 anode tip plate
400 electrically insulated dielectric
402 electrolyte countercharge plate
404 ion conductive fluid/polar solvent
407 pore
422 cathode
438 anode

### DETAILED DESCRIPTION

FIG. 1A shows a sectioned electrode 108 with a flat curved base 110, and a sharp tip 106. The electrode is surrounded by electrically insulating dielectric 100. The electrode 108 is sandwiched above by a circular capacitor plate 102, and below by a flat capacitor plate 112. The tip plate 102 and the base plate 112 are both surrounded by electrically insulating dielectric 100. The electrode and the base capacitor plate are separated from the tip plate by fluid 104. The tip of the electrode 106 is the only electrically conductive material that is in contact with the fluid 104.

FIG. 1B shows an images of two sectioned electrodes as first introduced in FIG. 1A, including sandwiching insulated plates. The cathode 122 is surrounded by electrically insulating dielectric 100 except for the cathode tip 124 that is exposed to the oxidant fluid interfacial layer 126. The cathode tip plate 128 is surrounded by dielectric 100. The cathode base plate 120, is surrounded by electrically insulating dielectric 100. The anode 138, is surrounded by electrically insulating dielectric, except for the anode tip 136 that is exposed to the reducing fluid interfacial layer 134. The anode tip plate 132 is surrounded by electrically insulated dielectric 100. The anode base plate 140 is surrounded by electrically insulated dielectric 100. The anode and cathode tips plates are separated by an ion conductive media 130.

The spacing of the components shown in FIG. 1B is intended to be flexible. In FIG. 1B the electrodes and insulated plates have been lined up to simplify the operational description. However, a variation in the spacing is acceptable, so long as the anode and cathode may be exposed to an electric field. A different geometry is introduced in FIGS. 2A-2E.

FIG. 1C shows a schematic of a simple electrical circuit and electrical connections to the electrically conductive components of FIG. 1B. A voltage supply 154, introduces charge to the cathode tip plate 128 and anode tip plate 132. This same power supply may optionally polarize base plates 120 and 140. The cathode 122 is connected to the anode 138 through the load 156, and a storage capacitor 152. The cathode may optionally charge the anode base plate 140. The anode may optionally charge the cathode base plate 120.

FIGS. 2A, 2B show sectioned views of an electrode array. The array represents a structure prepared using lithographic methods, and subsequently separated from the substrate. Structural components that provide precision separation of the elements of the array are not shown in FIGS. 2A-2D, in order to simplify the operational description. The array contains components similar to those introduced in FIGS. 1A, 1B, 1C. The electrode 208, is now approximately the shape of a wedge, and the tip of the wedge 206 faces the tip plate 202. The tip plate 202 and base plate 212 are surrounded by electrically insulating dielectric 200. The wedge electrode base 210, the tip plates 202 and base plates 212 all provide electrical connection so that the array may be extended.

FIG. 2C shows a sectioned exploded view of a cathode and anode array separated by layers of ion conductive media 226, 230, 234. Cathodes 222, are partially or completely immersed in ion conductive media 226. The cathodes terminate in cathode tips 224. The cathode tip plate 228 is surrounded by electrically insulating dielectric 200. The cathode base plate 220 is surrounded by electrically insulating dielectric 200 and is sandwiched by one or two cathodes. Layers 226, 230 and 234 are ion conductive. Layer 226 also serves as the oxidant fluid interface, for example diffused with air. Layer 234 also serves as the reducing fluid interface, for example diffused with fuel. The anodes 238 are partially or completely immersed in layer 234. The anodes terminate in tips 236. The anode tip plate 232 is surrounded by electrically insulating dielectric 200. The anode base plate 240 is surrounded by insulating dielectric 200 and is sandwiched by one or two anodes.

FIG. 2D shows a perspective view of FIG. 2C. In this view the cathode array is separated from the anode array 244 by three layers of ion conductive media 226, 230, 234. Scaffolding, spacing, and structural elements have been omitted to clarify the operational description. The spacing of the components shown in FIG. 2A-2E is intended to be flexible. The size and shape of the components may be varied. For instance the vertical thickness of the wedge electrode may be reduced or enlarged. The distance between the wedge tips and the tip plates may be reduced. Variation in the spacing and dimensions is acceptable, so long as the operational goals of ion generation, ion conduction and reaction completion are met for a specific fuel and oxidant combination.

FIG. 2E shows a schematic of a simple electrical circuit and electrical connections to the electrically conductive components of FIGS. 2C-2D. A voltage supply 254, introduces charge to the cathode tip plate 228 and anode tip plate 232. The power supply may optionally charge base plates 220 and 240 with a reverse polarity. The cathode 122 is connected to the anode 238 through the load 256, and a storage capacitor 252. The cathode may charge the anode base plate 240. The anode may charge the cathode base plate 220.

FIG. 3A shows a sectional view of a cathode 322, and anode 338. The blunt backsides of the cathode and anode face each other, separated by electrically insulating dielectric 300. The sharp cathode tips 324 point towards electrically insulated cathode tip plate 328 and is in contact with the cathode fluid and cathode fluid flow 301. The sharp anode tips 336 point towards the electrically insulated anode tip plate 332 and is in contact with the anode fluid and anode fluid flow 303. Layers of the electrically insulating dielectric 300 jut into the fluid flow and protect the anode and cathode tip from flow friction. The ion conductive media/electrolyte 330 lies downstream of the electrode assembly and is in contact with and separates the cathode fluid flow 301 and anode fluid flow 303.

FIG. 3B shows a sample electrical connection to the electrically conducting parts of FIG. 3A. A voltage supply 354 injects positive charge into the cathode tip plate, and negative charge into the anode tip plate 332. The cathode plate 322 and the anode plate 338 may be connected to storage capacitor 352 and the load 356.

FIG. 4A shows an ion conductive assembly. The countercharge plate 402 is electrically insulated from the ion conductive fluid 404 by electrically insulating dielectric layer 400. The cathodes 422 and anodes 438 are exposed to the ion conductive fluid 404 and positioned in the near vicinity of the dielectric 400 surface. The ion conductive fluid 400 fills the pore space 407 between dielectric layers 400. Structures that provide spacing/scaffolding are not shown in order to simplify the operational description. The regular size, and ordering of the components indicates a structure that may be extended indefinitely in the assembly plane.

The dimensions of the components in FIGS. 1-4 may vary. This variation may include small dimensions created by lithographic methods. This variation may include pushing miniaturization to the resolution limit of the lithographic method. This variation may include minimizing geometry to nanoscale dimensions resulting in small, sharp nanoscale electrode tips and tiny clearances between the electrode tip and tip plate. The dimension may be such that if exposed to a vacuum and voltage is correctly applied, field emission occurs from the cathode tips at low voltages.

### Operation:

FIG. 1A introduces a single electrode 108 bracketed by insulated capacitor plates 102, 112. The function of the capacitor plates is to immerse the electrode in an externally supplied electric field. For example, when functioning as a cathode, the tip plate 102 is supplied with a positive charge, and the base plate is supplied with a negative charge. The resulting electric field induces electrostatic induction in electrode 108 resulting in negative charge accumulating/piling up at the electrode tip 106. At the correct field strength, electric charge moves from the electrode tip 106 into the surrounding fluid space 104, creating ions. These ions will move towards the surface of the dielectric 100 surrounding the tip plate. While the electric field tends to move ions toward the surface of the dielectric, the Boltzmann energy distribution, and the chemical potential gradient allow some ions to drift away from the tip plate.

FIG. 1B presents an arrangement of two electrodes, with sandwiching plates immersed in and separated by ion conductive media. The layers of media 126, 130, and 134 may be composed of polar solvents, gels, solid electrolytes, nonpolar layers diffused with phase change catalysts, ion conductive membranes, insulated, charged wires and/or any combination thereof. 126, 130, and 134 promote the passage of ions, but resist electrical current flow. Layer 126 also serves as the oxidant fluid interface, for example diffused with oxygen molecules. Layer 134 also serves as the reducing fluid interface, for example, diffused with fuel molecules. Cathode tip plate 128 may be infused with positive charge. The positive charge influences charge distribution in the cathode 122. Negative charge congregates in the tip 124, and leaks into fluid layer 126, resulting in the creation of oxygen ions. Anode tip plate 132 is infused with negative charge. The negative charge influences charge distribution in the anode 138. Positive charge congregates in the tip of the anode 136, and leaks into fluid layer 134, resulting in the creation of fuel ions. The cations encounter an electrostatic attraction towards the surface of the dielectric surrounding the anode tip plate 132, 100. The anions encounter an electrostatic attraction towards the surface of the dielectric surrounding the cathode tip plate 128, 100. However these ions are not static and immovable. A Boltzmann distribution of energies and chemical potential ensure that some ions move deeper into ion conductive layer 130. Anions that cross layer 130 may react with cations resulting in reaction completion. Or cations that cross layer 130 may react with anions also resulting in reaction completion.

The dimensions of the components in FIG. 1A and FIG. 1B are sufficiently small, such that if exposed to a vacuum, field emission occurs from the cathode tips at small voltages. The electrodes in FIGS. 1,2,3 all leak charge, into reactant fluids, and this leakage occurs in the absence of any direct electrical power connection to the electrodes. Charge is induced to concentrate at the electrode/reactant fluid interface, and this concentration is increased in the presence of sharp tips, such as anode tip 136 and cathode tip 124. The charge concentration occurs due to electrostatic induction in the electrode. The electrostatic induction is caused by the external application of an electric field.

If the sample oxidant fluid diffusing into layer 126 is air, then the cathode assembly shown in FIG. 1B is functioning as an air cathode. Air cathodes are used in fuel cells as well as metal air batteries, and the method claims apply to both. FIG. 1B also presents a geometry of components that has been straightened to simplify the operational description. However, plate position and relative geometry of the plates, electrodes and ion conductive layers may be varied to best suit the chemical activation requirements of the fuel cell design. A different type of geometry, possibly more suitable to lithographic manufacturing processes, is introduced in FIGS. 2A-2D.

FIG. 1C shows a schematic electrical circuit with electrical connections to the electrically conductive parts of the figure. In this figure a voltage source 154 charges the cathode tip plate with a positive potential, and the anode tip plate with a negative potential. This voltage source may optionally charge (with a crossover connection) the cathode base plate 120 and the anode base plate 140. The applied potential in the tip plates causes charge to leak off the cathode 124 and anode 136 tips. The countercharge remaining in the electrodes results in the charging of the storage capacitor 152. The charge stored in capacitor 152 may be discharged through the load 156. The cathode potential may optionally charge the anode base plate 140. The anode potential may optionally charge the cathode base plate 120.

FIGS. 2A, 2B show electrode arrays in sectional and perspective views. FIGS. 2A and 2B include similar components as introduced in FIGS. 1A 1B. However, the geometry has been changed. The electrodes 208 are approximately wedge-shaped. The tip of these electrodes 206 refers to the sharp end of the wedge. The electrodes are sandwiched by a base plate 212 and tip plate 202. Both the base and tip plates are electrically insulated by a layer of dielectric 200. FIG. 2A shows a section view orthogonal to the lithographic plane. The perspective view, FIG. 2B, shows a total of 12 electrode tips. The symmetry of the array and the electrical connections 202, 210, 212, shown in the section plane, indicate that this array may be repeated and extended indefinitely in either direction along the lithographic plane. The wedge shape of the electrodes indicates the shape resulting from the top down application of standard lithographic techniques—coat, mask, expose, etch, rinse, repeat, etc. In contrast to the extraordinary complexity of modern microprocessor manufacturing, the array shown in FIGS. 2A, 2B has only a few layers, which results in a relatively simple design achieved with a minimum of process steps.

The array shown in FIGS. 2A, 2B differs from FIG. 1B operationally, in that all the electrodes in the array are assigned the same polarity. The array may serve as an anode array, or cathode array, but not both at the same time. For example, when functioning as a cathode, the electrode tip plate 202 is assigned a positive voltage. Negative charge is attracted to the tip 224 end of the wedge electrodes and some negative charge leaks from the wedge tips into the surrounding fluid media. The negative voltage assigned to the base plate 212 also helps to promote charge leakage from the tip.

FIGS. 2C, 2D show the cathode array 242, separated from the anode array 244 by layers of ion conductive media 226, 230, 234. Electrical charge leaks from the tips of the cathode wedge electrodes 224 in the cathode array, reducing oxygen and creating oxygen ions. Electrical charge leaks from the anode tips 236, oxidizing the fuel and creating fuel ions. Reactant ions drift across ion conductive media 230, leading to reaction completion. If the oxidative fluid diffusing into layer media 226 is air, then the cathode assembly in FIGS. 2C, 2D is functioning as an air cathode. The function of this air cathode is not limited to fuel cells, but also applicable to air cathode batteries, and this function is included in the method claim.

FIG. 2E shows a schematic of a simple electrical circuit and electrical connections to the electrically conductive components of FIGS. 2C-2D. A voltage supply 254, introduces charge to the cathode tip plate 228 and anode tip plate 232. The power supply may optionally charge base plates 220 and 240 with a reverse polarity. The cathode 122 is connected to the anode 238 through the load 256, and a storage capacitor 252. The cathode may charge the anode base plate 240. The anode may charge the cathode base plate 220.

FIG. 3A, 3B contain the same structural elements as shown in previous figures, but with a new geometry. A voltage supply 354 injects positive charge into cathode tip plate 328 and negative charge into anode tip plate 332. The anode 338 and cathode 322 are subjected to an electric field. Negative charge concentrates in the cathode tips 324, and leaks into cathode fluid flow 301. Positive charge concentrates in the anode tips 336 and leaks into the anode fluid flow 303. Cathode fluid flow 301, and anode fluid flow 303, move these charges downstream to the electrolyte 330. The fluid flow increases the rate of reactant ionization. Ions cross the electrolyte leading to reaction completion. The countercharge remaining on the electrodes is stored in the capacitor 352, and/or used to power the load 356. The dielectric 300 provides electrical insulation, but also protects the anode and cathode tips from the frictional flow of the anode and cathode fluids.

FIG. 4 shows a series of conductive plates 402 that are isolated from ion conductive fluid 404 by electrically insulating dielectric 400. Charge is introduced to the plates 402 in order to induce a monolayer of ions to form on the insulator 400 surface. The counter ion in the ion conductive fluid is reduced or eliminated. The reduction/elimination of the counter ion also reduces/eliminates contamination by the counter ion. The voltage assigned to plate 402 may be raised to a maximum voltage just short of dielectric breakdown. For example, if the ion conductive fluid is water, and the plates 402 are charged with a positive charge, negative charge leaks from the cathode 422 and forms a monolayer of hydroxide ions at the dielectric 400, fluid 404 interface. The anode 438, and cathode 422, are positioned close to the dielectric/fluid interface and function as working electrodes. The careful positioning of the electrodes may expose the electrodes to the nearby chemical environment which includes hydroxide ion. The fluid pore spaces 407 between dielectric insulation 400 now serve as an ion conduit, allowing the migration of anions between cathode and anode, on or in the near vicinity of the dielectric 400, fluid 404 interface. In this manner, ionic charge is transferred between cathode and anode. In this operational example, the anion flow may include both hydroxide and carbonate. In the absence of contaminating alkali cations, there is no formation of insoluble alkali carbonates. In general, the polarity of the voltage assigned to the plates 402 may be switched, thus allowing conduction of any species of ion.

I claim:

1. A fuel cell comprising:
a plurality of anode electrodes
a plurality of cathode electrodes
a plurality of reactant fluids
an ion conduction media, in contact with said reactant fluids and said electrodes, and separating the anode and the anode reaction fluid from the cathode and cathode reaction fluid
induction means for creating an electric field, the electric field influencing surface charge distribution of said electrodes
whereby electrical charge moves from the electrode to said reactant fluids, the improvement wherein reactant ionization is induced by exposing the electrode surfaces to an externally supplied electric field.

2. The fuel cell of claim 1 wherein induction means are provided by a plurality of electrically insulated capacitor plates comprising plates, electrically insulated covering and electrically insulated leads, the insulated plates contiguous to the electrode, ion conductive media, and reactant fluid.

3. The fuel cell of claim 1 wherein said ion conductive media includes additional components selected from the group consisting of polar solvent, liquid electrolyte, solid electrolyte, ion conductive membranes, solvent dissolved phase transfer catalysts, insulated electrically conductive plates, gels, spacers, and scaffolding.

4. The fuel cell of claim 1 wherein said electrodes are populated by a multitude of small electrically conducting surface tips whereby charge movement from said electrode surfaces to said reactant fluid is increased at the surface of small conducting tips.

5. The fuel cell of claim 1 wherein said electrodes are populated by a multitude of sharp electrically conducting surface tips, whereby charge movement from said electrode surfaces to said reactant fluid is increased by sharp tips.

6. The fuel cell of claim 1 further including reactant fluid flows, said flows contiguous to said anodes and said cathodes whereby ionized reactants are moved downstream to said ion conduction media, the improvement wherein the rate of reactant ionization is increased.

7. A method for ionizing chemical reactants
providing a reactant fluid
providing an electrode surface contiguous to said reactant fluid
providing induction means for creating an electric field, contiguous to said electrode surface and said reactant fluid, the electric field influencing surface charge distribution of said electrode surface
whereby electrical charge moves from the electrode surface to said reactant fluid, the improvement wherein reactant ionization is induced by exposing the electrode surface to an externally supplied electric field.

8. The method of claim 7 wherein inductive means are provided by a plurality of insulated capacitor plates comprising: plates, electrically insulated covering and electrically insulated leads, the insulated capacitor plates contiguous with said reactant fluid and bracketing said electrode surfaces.

9. The method of claim 7 wherein said electrode surface includes a small electrically conducting tip whereby charge movement from said electrode surface to said reactant fluid is increased at the surface of a small electrically conductive tip.

10. The method of claim 7 wherein said electrode surface includes a sharp electrically conducting tip, whereby charge movement from said electrode surface to said reactant fluid is increased at the point of a sharp electrode tip.

11. An ion conductive media comprising
a porous electrically insulated dielectric
a ion charged, ion conductive fluid contiguous to and surrounding said porous dielectric surface.
a plurality of countercharged electrically conductive plates said plates insulated by and encapsulated by said dielectric surface
whereby said countercharged plates promote ion conduction through said dielectric pores contiguous to said dielectric surface the improvement wherein counter ion concentration is reduced in said ion conductive fluid.

12. The ion conductive media of claim 11 further including a plurality of working electrodes, said electrodes contiguous to said ion conductive fluid and positioned near said dielectric surface
whereby ion flow in said porous dielectric permits ion conduction between the working electrodes.
